(19) United States
(12) Patent Application Publication
(10) Pub. No.: US 2023/0316797 A1
(43) Pub. Date: Oct. 5, 2023

(54) APPARATUS, SYSTEM, AND METHOD FOR PROVIDING INCREASED DETECTION ACCURACY

(71) Applicant: Schneider Electric Buildings Americas, Inc., Carrollton, TX (US)

(72) Inventors: Goran Stojcevski, Malmo (SE); Peter Sven Anders Lindgren, Bunkeflostrand (SE); Pierre François Veuillet, Voiron (FR)

(73) Assignee: Schneider Electric Buildings Americas, Inc., Carrollton, TX (US)

(21) Appl. No.: 18/128,552

(22) Filed: Mar. 30, 2023

Related U.S. Application Data
(60) Provisional application No. 63/325,405, filed on Mar. 30, 2022.

(51) Int. Cl. G06V 40/10; H04N 23/23; H04N 7/18; G06V 20/52; G06V 10/147; G06T 7/00

(52) U.S. Cl. CPC G06V 40/10; H04N 23/23; H04N 7/188; G06V 20/52; G06V 10/147; G06T 7/97; G06T 2207/30196; G06T 2207/30242; G06T 2207/30232; G06T 2207/10048

(57) ABSTRACT

Apparatuses, systems, and methods are described for providing increased detection accuracy. A system for may include a management system, a network, and a sensor device. The sensor device may include a first sensor which captures baseline data and current data associated with the space, a second sensor which detects motion within the space, and a processor which causes the first sensor to capture the baseline data based at least in part upon a predetermined time period having elapsed since detected motion by the second sensor, and further configured to cause the second sensor to capture the current data and perform a comparison operation on the current data and the baseline data.

### RELATED APPLICATION

The present application claims priority to U.S. Provisional Patent Application Ser. No. 63/325,405, filed on Mar. 30, 2022, and entitled APPARATUS, SYSTEM, AND METHOD FOR PROVIDING INCREASED DETECTION ACCURACY, which is incorporated by reference herein in its entirety.

### TECHNICAL FIELD

The present disclosure relates to improving detection systems. More particularly, the present disclosure relates to providing improved people counting operations by implementing a multi-sensor detection device, system, and method.

### BACKGROUND

Existing people counting sensors which use thermal imaging suffer deficiencies caused by their use of a static or not recent reference background image (such as an image taken at a specified time when a monitored space is believed to be vacant, for example daily at midnight) to compare to a current image for determining a number of people within the monitored space. Static or outdated background images might not reflect usage data, for example based upon heat profiles generated by lighting and other elements when a space is occupied. This may lead to inaccurate people counting during normal usage times. A camera may be used to capture images of a space which are analyzed to identify people within a space but suffers drawbacks in relation to applicable privacy rules and laws.

Problems exist when a background image is refreshed periodically. It is necessary to refresh the background image frequently to capture the variation in the conditions of the space over a time period (e.g., furniture, light/heat). The background image can be taken during times when people are generally not expected to be present in the space (e.g., after midnight in an office space). However, there is no guarantee that no one is present when a background image is taken. This could result in inaccurate counting of people in the space. Similarly, a user can verify that no one is present in the space and then instruct the sensor to capture the background image. However, this method requires manual intervention and is impractical to do frequently.

### SUMMARY

Implementations consistent with the present disclosure provide apparatuses, systems, and methods for improving the accuracy of people counting by a sensor device such as a people counting sensor. In accordance with the present disclosure, it is possible to configure a sensor (e.g., a Passive Infrared (PIR) sensor) to assist in determining an optimal or appropriate time to refresh baseline background data such as a baseline background image (e.g., using another sensor, such as a thermal imager, to obtain the baseline background image). This may include configuring a minimum no motion time for a monitored space before refreshing the baseline background image and configuring a trigger for refreshing the baseline background image. Current sensor data (e.g., current data such as a current thermal image of the space) may be compared to the refreshed background image to determine a count of people in the space. The count of people in the space may be output by the sensor device, for example to a building management system or control unit, for controlling one or more environment conditions of the space.

In accordance with aspects of the present disclosure, there are a plurality of conditions which may trigger a baseline background data update operation, including: a sensor device startup condition, a manual command, an automatic time configuration (e.g., once per day at night), and/or a smart refresh condition. The smart refresh condition might be configured to trigger a baseline background update operation when the refresh setting is designated automatic and the minimum time no motion is detected by the sensor device (e.g., using a PIR sensor thereof) is greater than zero (or a predetermined or dynamically determined time period has elapsed). The smart refresh condition might additionally or alternatively might be configured to trigger a baseline background capture operation upon a powering on or restart condition of a sensor device or whenever the sensor device is operating in a degraded mode and the minimum no motion time condition is satisfied. In this event, the baseline background image may be updated.

Implementations consistent with the present disclosure may provide increased people counting accuracy for a sensor device (e.g., a multi-sensor device) by leveraging a movement sensor to assist in determining when to update a baseline background image for use in people counting operations. Implementations consistent with the present disclosure may provide reduced costs and eliminate privacy issues related to camera-based people counting solutions.

Implementations consistent with the present disclosure provide a sensor device which detects the number of people in a monitored space. The sensor device uses a movement sensor (e.g., PIR sensor) to determine whether the space is occupied or unoccupied and captures a new baseline background image of the space using a sensor (e.g., thermal imager) if the space is unoccupied.

Thermal imagers can be used to detect people, for example by detecting a body heat profile. Thermal imagers can be integrated into sensor devices for general people counting, tracking live occupancy, and a range of security applications. Implementations consistent with the present disclosure may provide a multi-sensor device (e.g., in an overhead installation configuration) which implements people counting functionality. The multi-sensor device may be configured to fit discreetly onto a ceiling or other surface facing downwards and may be operable to count the number of people that pass underneath and/or that are currently within a monitored space using thermal imager technology of the multi-sensor device. A background image (e.g., a background or baseline thermal image) may be obtained at sensor start-up time, at a manually specified time, and/or automatically at a specific time configuration (e.g., at midnight each night).

To reach a high-level of accuracy of the people counting, a calibration algorithm may be implemented by a sensor device which uses thermal images captured by a thermal sensor, where a current or subsequent thermal image is compared to a background or baseline image. The background or baseline image may be an image obtained while a space that is being monitored is unoccupied.

To ensure that people are not in the field of view of a sensor device before taking a picture and starting a calibration cycle, a sensor device may utilize a PIR sensor. The PIR sensor may be configured to detect an amount of change in infrared radiation that occurs when a person moves by sensing a difference in temperature between the human body and the floor, walls, and other objects in the background. The sensor device may be configured to utilize a quad-type PIR sensor with Fresnel lens in various embodiments.

By combining a thermal imager and movement sensor technology for improved accuracy of people counting, implementations consistent with the present disclosure may provide benefits not previously known or obtained.

Implementations consistent with the present disclosure may include a sensor device for monitoring a space. The sensor may include a first sensor configured to capture baseline data and current data associated with the space, a second sensor configured to detect motion within the space, and a processor configured to cause the first sensor to capture the baseline data based at least in part upon a predetermined time period having elapsed since detected motion by the second sensor, the processor further configured to cause the second sensor to capture the current data and to perform a comparison operation on the current data and the baseline data. The first sensor may be a thermal imager. The second sensor may be a Passive Infrared (PIR) sensor. In various embodiments, the first sensor may be a thermal imager and the second sensor may be a PIR sensor. The comparison operation may perform people counting to determine a number of people within the space. The comparison operation may include comparing a reference background image as the baseline data to the current data. The reference background image may be a baseline background thermal image captured by the first sensor.

Further implementations according to aspects of the present disclosure may provide a system for monitoring a space. The system may include a management system, a network, and a sensor device. The sensor device may include a first sensor configured to capture baseline data and current data associated with the space, a second sensor configured to detect motion within the space, and a processor configured to cause the first sensor to capture the baseline data based at least in part upon a predetermined time period having elapsed since detected motion by the second sensor, the processor further configured to cause the second sensor to capture the current data and to perform a comparison operation on the current data and the baseline data. The first sensor may be a thermal imager. The second sensor may be a Passive Infrared (PIR) sensor. In various embodiments, the first sensor may be a thermal imager and the second sensor may be a PIR sensor. The comparison operation may perform one or more people counting operations to determine a number of people within the space. The comparison operation may include comparing a reference background image as the baseline data to the current data. The reference background image may be a baseline background thermal image captured by the first sensor.

According to further aspects of the present disclosure, provided is a method for providing improved people counting. The method includes obtaining baseline data relating to a space, selectively replacing the baseline data with new baseline data based at least in part upon a parameter of the space, obtaining current data relating to a space, comparing the current data to the baseline data, and determining a number of people within the space based at least in part upon the comparison between the current data to the baseline data. The method may further include performing one or more of a correction or a stabilization operation on the current data. The e comparing the current data to the baseline data may include comparing a baseline background thermal image to the current data.

According to further aspects of the present disclosure, provided is a non-transitory computer-readable storage medium having stored thereon sequences of instructions which when executed by a processor cause the processor to obtain baseline data relating to a space, selectively replace the baseline data with new baseline data based at least in part upon a parameter of the space, obtain current data relating to the space, compare the current data to the baseline data, and determine a number of people within the space based at least in part upon the comparison between the current data to the baseline data. The processor may further perform one or more of a correction or a stabilization operation on the current data. The e comparing the current data to the baseline data may include comparing a baseline background thermal image to the current data.

### BRIEF DESCRIPTION OF THE DRAWINGS

FIG. 1 illustrates a front view of an embodiment of a sensor device according to aspects of the present disclosure.

FIG. 2 illustrates a partial block diagram of an embodiment of a sensor device of FIG. 1 according to aspects of the present disclosure.

FIG. 3 illustrated a partial block diagram of an embodiment of a system according to aspects of the present disclosure.

FIG. 4 illustrates a process for obtaining and updating baseline data according to aspects of the present disclosure.

FIG. 5 illustrates a process for processing current data by a sensor device according to aspects of the present disclosure.

FIG. 6 illustrates an example of a process for performing a people count operation according to aspects of the present disclosure.

FIG. 7 illustrates an exemplary embodiment of performing people counting based upon raw data obtained by a sensor device according to aspects of the present disclosure.

FIG. 8A illustrates a partial block diagram of a space monitored by a sensor device according to aspects of the present disclosure

FIG. 8B illustrates a partial block diagram of a space having a plurality of zones each monitored by a respective sensor device according to aspects of the present disclosure.

FIG. 9 illustrates an example of a limited monitoring zone of a sensor device in for a space having multiple zones as illustrated by FIG. 8B according to aspects of the present disclosure.

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

Identical reference numerals have been used, where possible, to designate identical elements that are common to the figures. However, elements disclosed in one embodiment may be beneficially utilized on other embodiments without specific recitation.

### DETAILED DESCRIPTION

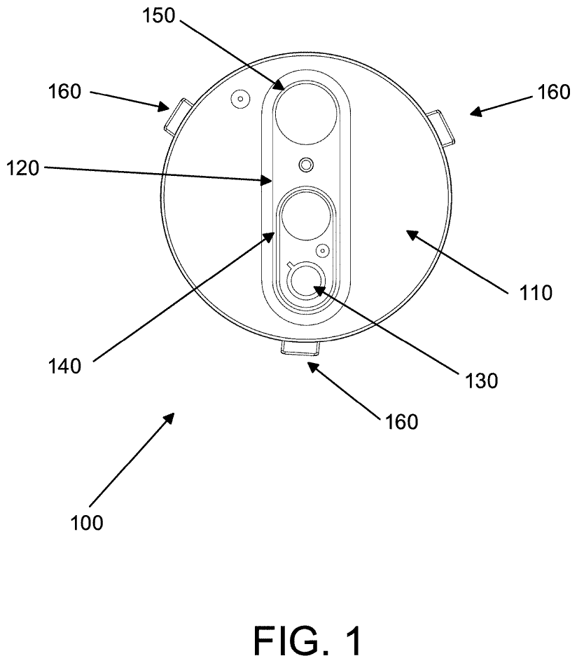

FIG. 1 illustrates a front view of an embodiment of a sensor device 100 according to aspects of the present disclosure. The sensor device 100 includes a housing for housing various components of the sensor device 100, including a plurality of sensing elements (e.g., sensors or sensing device(s)). The sensor device 100 may include one or more of a cover 110, a sensor module 120, a first sensor 130, a second sensor 150, a third sensor 140, and/or one or more springs 160. Although illustrated as having three sensors, it should be appreciated that a sensor device 100 may have any number of sensing elements including, but not limited to, a Passive Infrared (PIR) sensing element, a thermal imaging sensing element, a visual sensing element, an audible sensing element, a radar sensing element, or any other sensing element or combination thereof. Furthermore, it should be appreciated that although being described as a sensor, the first sensor 130, the second sensor 150, and/or the third sensor 140 may be any sensing element or component (or any device or element useable in conjunction with a sensor or sensing element) without departing from the spirit and scope of the present disclosure. Two or more sensing elements of the sensor module 120 may be useable together to perform at least one operation, such as a people counting operation according to various embodiments.

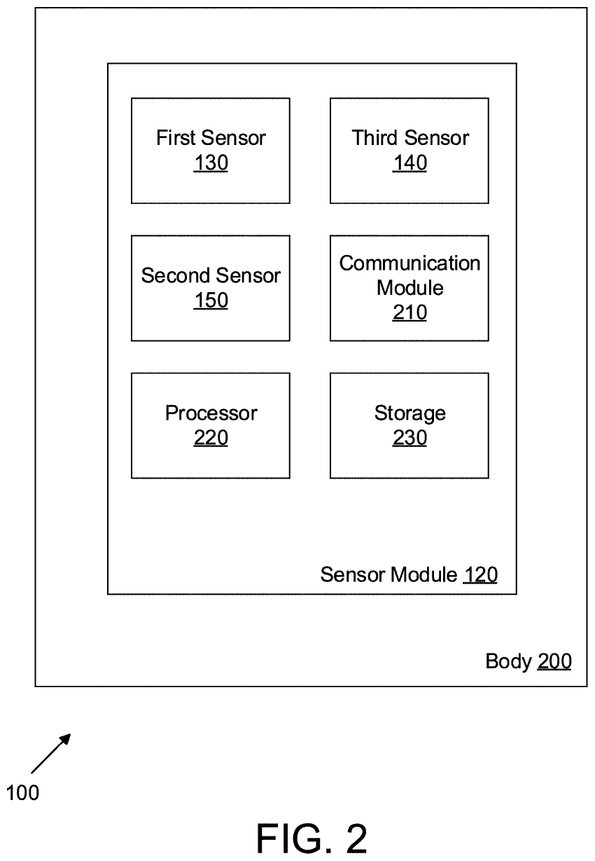

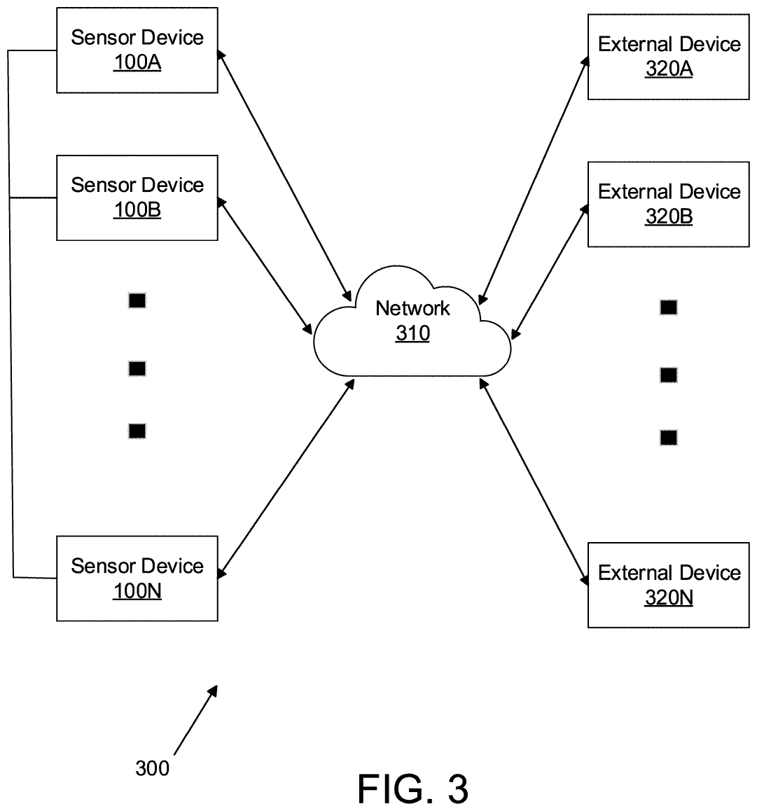

FIG. 2 illustrates a partial block diagram of an embodiment of a sensor device of FIG. 1 according to aspects of the present disclosure. The sensor device 100 includes a body 200 (e.g., including or otherwise coupleable to the cover 110 illustrated by FIG. 1). The sensor module 120 includes a plurality of sensing elements (e.g., first sensor 130, second sensor 150, and third sensor 140), along with one or more communication module 210, a processor 220, and/or a storage 230. Although not illustrated by FIG. 2, various components of the sensor module 120 may be communicatively coupled or coupleable to one another via a conductive bus. The sensor module 120 may include one or more Printed Circuit Board (PCB) sections configured to include or operate in accordance with one or more of the first sensor 130, the second sensor 150, the third sensor 140, the communication module 210, the processor 220, and/or the storage 230. Although illustrated and described with reference to a common module, it should be appreciated that one or more of the first sensor 130, the second sensor 150, the third sensor 140, the communication module 210, the processor 220, and/or the storage 230 or portion thereof may be a part of the sensor device 100 or may be communicatively coupleable thereto, for example via a network such as network 310 as illustrated by FIG. 3.

The communication module 210 may provide at least one wired and/or wireless interface for transmitting data or information from the sensor device 100 and/or for receiving data or information at the sensor device 100. The communication module 210 may be configured to communicate via at least one communication network, such as network 310 described herein with reference to FIG. 3. The processor 220 may be one or more hardware and/or software processing element(s) configured to perform at least one operation of the sensor device 100 or in furtherance thereof. The processor 220 may take the form a microprocessor in various embodiments. Although not illustrated by FIG. 2, the processor 220 may include one or more volatile or non-volatile memories useable by the processor 220 to execute one or more commands. One or more sets of instructions may be stored at either a local memory or storage of the processor 220 and/or at the storage 230. The storage 230 may include any volatile or non-volatile storage medium configured to store or access one or more sets of data or information usable by or in conjunction with the sensor device 100.

In an example embodiment, the first sensor 130 is a thermal imager. The thermal imager is configured to capture a thermal image profile of a space associated with the sensor device 100. A baseline thermal image (e.g., a thermal background profile or baseline data) may be generated by the thermal imager and may be selectively stored at the storage 230. Additionally or alternatively, the thermal background profile, representation thereof, or parameter associated therewith may be transmitted from the sensor device 100 via the communication module 210 (for example, to one or more external device(s) 320 as described herein with reference to FIG. 3.

The second sensor 150 may be a sensor configured to detect motion within a space associated with the sensor device 100. The second sensor 150 may be, for example but not limited to, a Passive Infrared (PIR) sensor, a radar sensor, a Time of Flight sensor, or any other sensor or sensing element configured to detect motion within the space associated with the sensor device 100 or to provide information capable of use in detecting motion within the space associated with the sensor device 100. The sensor device 100 may be configured to obtain a current thermal image (e.g., current data) via the first sensor 130. The current thermal image may be obtained at a periodic time and/or at a dynamically determined time. In various embodiments, the new baseline thermal image may be obtained after a predetermined time has lapsed since motion was detected within the space by the second sensor 150. The predetermined time may include for example, a time of two minutes, five, minutes, or ten minutes, although longer or shorter periods of time may be used without departing from the spirit and scope of the present disclosure. The predetermined time may be selected, for example, based upon at least one operational characteristic of one or more of the sensor device 100 and/or the space. For example, the predetermined time may be determined based at least upon a size of the space, an activity level of the space, a lighting or heat parameter associated with the space, or any other factor(s). The current thermal image may be stored at the storage 230 of the sensor device 100.

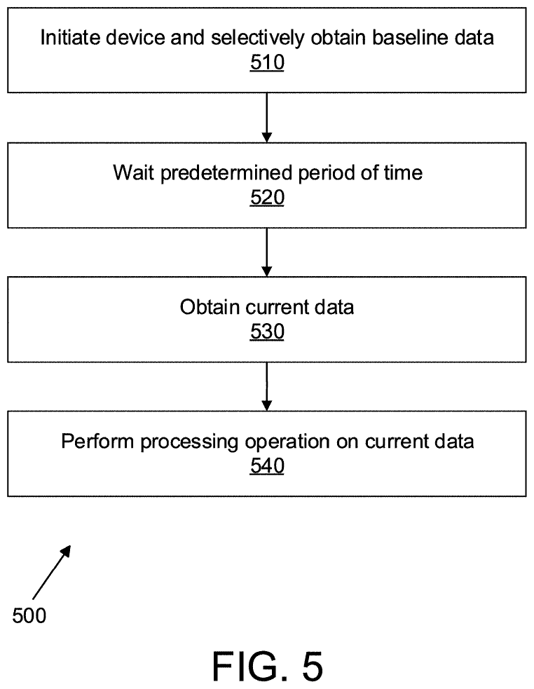

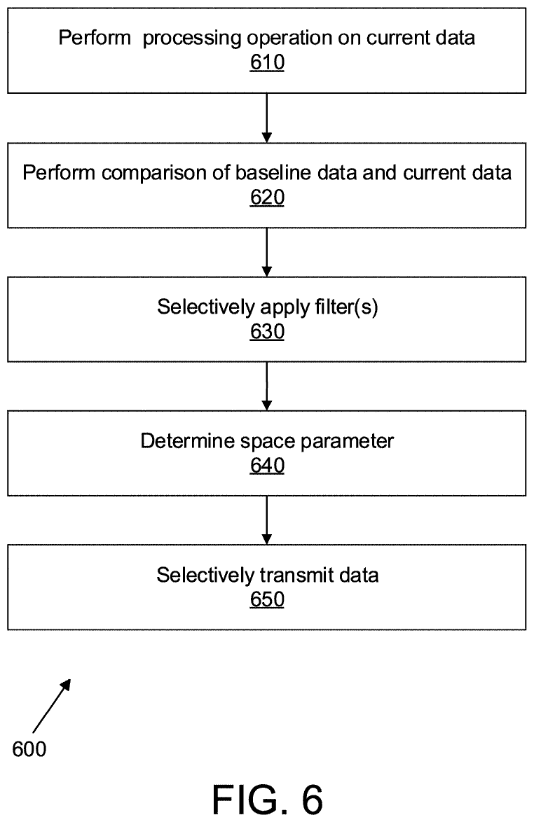

The sensor device 100 may be configured to obtain a current thermal image of the space at a predetermined time. The predetermined time may be two minutes in an example embodiment, although any period of time may be used consistent with the present disclosure. The current thermal image may be compared against the baseline thermal image to perform at least one operation (for example, using the processor 220). The at least one operation may include a people counting operation configured to determine the number of people currently within the space. An example of a people counting operation associated with a sensor device 100 is illustrated and described herein with reference to FIGS. 5-6.

The communication module 210 may be configured to transmit at least one set of information relating to a current people count, for example via the network 310. The at least one set of information may include, but is not limited to, the current thermal image, a parameter of the current thermal image, the baseline thermal image, a parameter of the baseline thermal image, a people count number, coordinate information relating to one or more of the current thermal image and/or baseline thermal image, and/or any other data or information associated with the sensor device 100, the current thermal image, and/or the baseline thermal image. The transmitted at least one set of information may be obtained by an external device 320, selectively associated with a management system. Before taking a background image the application can make sure that no people are present in the area by using the PIR function.

FIG. 3 illustrated a partial block diagram of an embodiment of a system according to aspects of the present disclosure. The system 300 includes a plurality of sensor devices 100A, 100B, . . . , 100N communicatively coupleable to a network 310, for example via a respective communication module 210 of one or more of the sensor devices 100A, 100B, . . . , 100N. Additionally or alternatively, two or more of the sensor devices 100A, 100B, . . . , 100N may be communicatively coupleable to one another, for example using one or more wired and/or wireless connections (e.g., via respective communication modules 210 of the two or more of the sensor devices 100A, 100B, . . . , 100N). In various embodiments, two or more of the sensor device 100A, 100B, . . . , 100N may be coupleable to one another in a daisy chain configuration. Additionally or alternatively, two or more of the sensor devices 100A, 100B, . . . , 100N may be communicatively coupleable using one or more wired and/or wireless means, for example via the network 310.

The network 310 may include one or more wired and/or wireless communication mediums communicatively coupleable to one or more of the sensor devices 100A, 100B, . . . , 100N, and optionally to one or more external devices 320A, 320B, . . . , 320N. The one or more external devices 320A, 320B, . . . , 320N may be any electronic device capable of communicating with the network 310 and configured to perform at least one operation, store one or more sets of data or information, or to assist in the performance and/or storage of one or more sets of data or information used by or useable by one or more of the sensor devices 100A, 100B, . . . , 100N. The one or more external devices 320A, 320B, . . . , 320N may be configured to operate as or otherwise in conjunction with a distributed system, such as a cloud-based storage and/or processing network or system. The network 310 may be any public and/or private network(s), and my include, for example, a local area network (LAN), wide area network (WAN), the Internet, or any other network type or protocol.

In various embodiments, at least one external device 320 may be configured to perform one or more operations or to assist in performing one or more operations of a management server. For example, at least one external device 320 may be configured to receive information from one or more sensor device 100. This may include a sensor device 100 providing information relating to a monitored space, such as a people count number, coordinate information relating to the monitored space, or any other information relating to the sensor device 100, to a space associated with the sensor device 100, or to any other data or information relating to the sensor device 100 and/or space. In one example, the sensor device 100 is configured to transmit to at least one external device 320 a people count value and coordinate information relating to one or more detected people within a monitored space. Additionally or alternatively, other types of data or information associated with the sensor device 100 and/or space may be transmitted from the sensor device 100 to at least one external device 320, including a baseline thermal image, a current thermal image, an updated baseline thermal image, and/or any other data or information associated with the sensor device 100 and/or space associated with the sensor device 100.

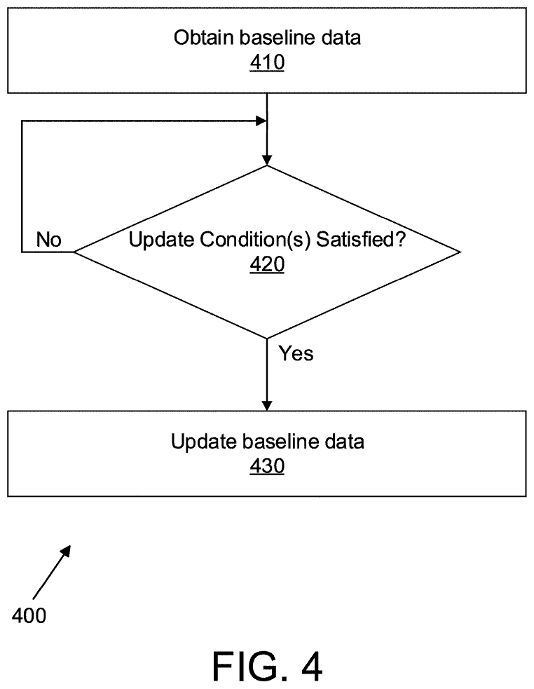

FIG. 4 illustrates a process for obtaining and updating baseline (e.g., background) data according to aspects of the present disclosure. The process 400 includes an operation 410 to obtain baseline data. The baseline data may comprise data relating to a space associated with a sensor device 100. The baseline data may be thermal image data of a space associated with a sensor device 100 in various embodiments. The baseline data may be obtained, for example, upon installation and/or powering on a sensor device 100 in some embodiments. Additionally or alternatively, at least a portion of baseline data may be obtained after a predetermined or dynamically determined time period has elapsed since an installation or powering on of the sensor device 100. It is determined at an operation 420 whether any update condition(s) are satisfied. Update conditions might include, for example, a predetermined time period elapsing since baseline data was previously obtained, an occupancy status of a space associated with a sensor device 100, a predetermined time of day, or the like, either alone or in combination. In various embodiments, the update conditions may include determining that the space has been unoccupied for at least a predetermined and/or dynamically determined period of time. For example, information from a second sensor 150 (such as a PIR sensor) of a sensor device 100 might indicate that no movement has occurred within the space for a time period (e.g., five minutes or ten minutes) and thus the space is determined to be unoccupied. The sensor device 100 might then obtain new baseline data (e.g., a new thermal image) and update the baseline data at an operation 430. The new baseline data may be stored, for example, at the storage 230 of the sensor device 100. One or more of the operations described with reference to FIG. 4 may be performed by the sensor device 100, for example using a processor 220 thereof. Additionally or alternatively, each of the operations illustrated by FIG. 4 may be implemented by a sensor device 100.

FIG. 5 illustrates a process for processing current data by a sensor device according to aspects of the present disclosure. The process includes initiating a sensor device 100 and selectively obtaining baseline data at an operation 510. Initiating a sensor device 100 may include powering on the sensor device 100, restarting the sensor device, transitioning the sensor device 100 from a degraded mode to a non-degraded mode, or the like. Baseline data may be selectively obtained by the sensor device 100 upon device initiation. A pause or delay is capable of being implemented prior to obtaining the baseline data by the sensor device 100. The baseline data may include one or more sets of information or data regarding a monitored space. The baseline data may include background data relating to the space, such as a background thermal image of the space obtained by a sensor (e.g., thermal imager) of the sensor device 100. The sensor device 100 may be configured to wait a predetermined amount of time at an operation 520. Although described as a predetermined time, it should be appreciated that a dynamically determined period of time may be implemented at operation 520, for example in relation to one or more operational characteristics of the sensor device 100 and/or the monitored space. Current data may be obtained by the sensor device 100 at an operation 530. Current data obtained at the operation 530 may include image data, such as a current thermal image of a space using a sensor of the sensor device 100 (e.g., thermal imager). At least one processing operation may be performed on the current data at an operation 540. This may include performing one or more data processing operations on the current data itself. This may include performing at least one image processing operation on at least a portion of the current data or representation thereof.

FIG. 6 illustrates an example of a process for performing a people count operation according to aspects of the present disclosure. The process 600 includes performing a processing operation on current data at an operation 610. This may include the at least one processing operation performed at the operation 540. For example, at least one image correction process may be performed at the operation 610. This may include performing at least one of image correction and/or stabilization. A calculation of a current thermal image as the current data may be performed. A comparison of baseline data and current data may be performed at an operation 620. This comparison may include comparing a reference background (e.g., a baseline background thermal image) to the current data. The reference background may be configured in a manner previously described in a manner so as to represent a thermal profile of a monitored space such that no people were within the space when the reference background was obtained. In performing operation 620, one or more objects may be identified or extracted, for example by means of background subtraction, either prior to or as part of the comparison of the current data to the baseline data. In various embodiments, the one or more objects may be identified based upon having a different thermal profile than compared to the baseline data and/or a surrounding area of the current data. This may include identifying one or more areas having a higher thermal measurement than compared to the baseline data and/or than an area adjacent to the one or more areas in the current data. One or more filters may be selectively applied at an operation 630. The one or more filters may be used to identify one or more regions of interest associated with the current data. This may include distinguishing between one or more areas having a thermal profile determined to be a person's body as opposed a localized heat source, such as a heated beverage, a light source, a person's limb, etc. After application of the filter(s), the process continues to an operation 640 where at least one space parameter is determined. A space parameter may include a people count within the space, one or more coordinates for at least one identified person within the space, an ambient temperature associated with one or more portions of the space, or any other information contained within or otherwise associated with the area based at least in part upon one or more of the baseline data and/or current data. At least one set of data may be transmitted from the sensor device at an operation 650. The transmitted data may include, for example, a people count number associated with the space, one or more of coordinates for at least one identified person within the space, at least one ambient temperature associated with one or more portions of the space, and/or any other information associated with the sensor device 100 and/or corresponding space.

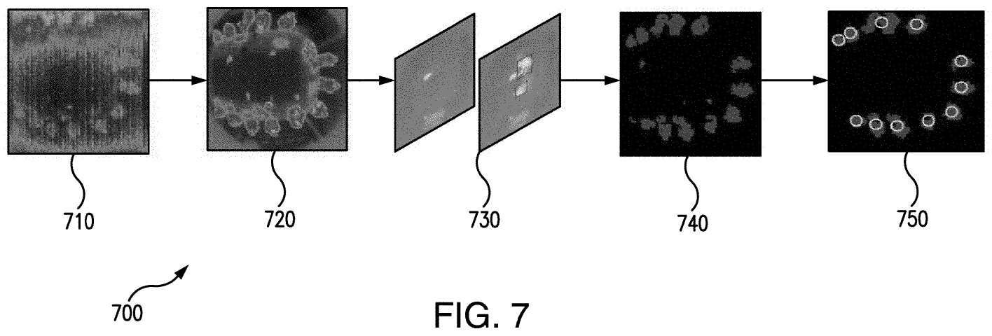

FIG. 7 illustrates an exemplary embodiment of performing people counting based upon raw data obtained by a sensor device 100 according to aspects of the present disclosure. The process flow 700 includes raw data 710 obtained by a sensor device 100 (e.g., by a sensor thereof, such as a thermal imager). Image correction and/or stabilization may be performed on the data to generate a corrected image 720. A comparison of baseline data and current data may be performed to extract one or more hot objects, as reflected by image comparison 730. One or more filters may be applied to the current data based at least in part upon the comparison between the baseline data and the current data and/or the identified one or more hot objects to obtain region of interest data 740. The region of interest data may be further processed to detect people in the region of interest data and to calculate the number of and the position(s) of the people counted to provide count data 750. This count data may be stored at the sensor device 100 and/or may be selectively transmitted from the sensor device 100, for example via the network 310 for use by a management system. Additionally or alternatively, the sensor device 100 may be configured to transmit a people count value, one or more sets of coordinates of one or more person(s) identified within the space, and/or any additional information relating to the sensor device 100 and/or space.

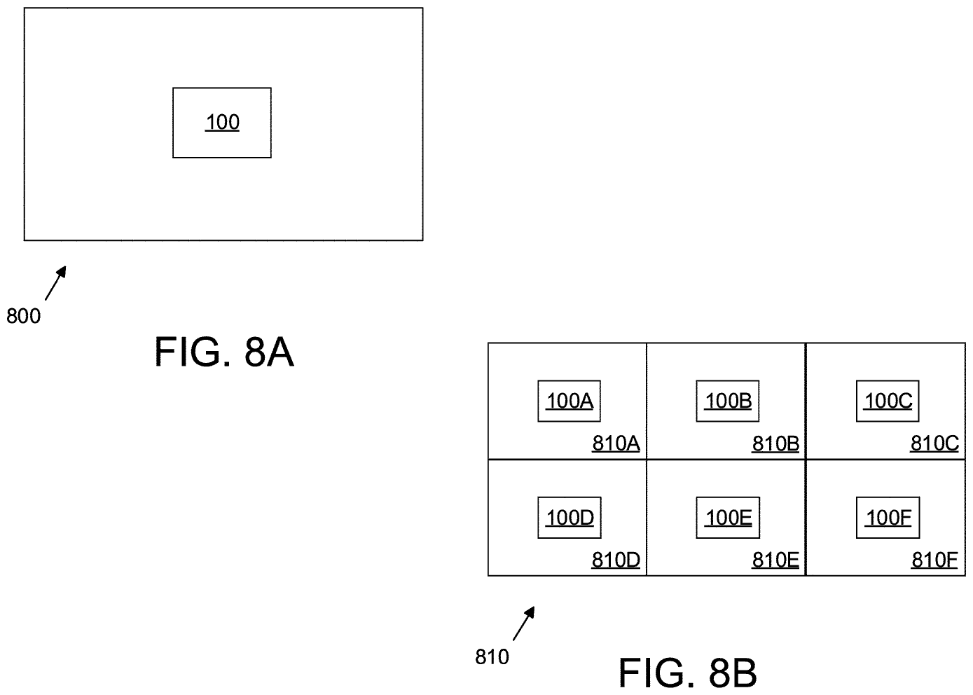

FIG. 8A illustrates a partial block diagram of a space monitored by a sensor device according to aspects of the present disclosure. As illustrated by FIG. 8A, a space 800 is monitored by a single sensor device 100. FIG. 8B illustrates a partial block diagram of a space having a plurality of zones (e.g., sectors) each monitored by a respective sensor device according to aspects of the present disclosure. The space 810 includes a plurality of zones 810A, 810B, 810C, 810D, 810E, and 810F, each associated with a respective sensor device 100A, 100B, 100C, 100D, 100E, 100F. Although illustrated as having six zones, it should be appreciated that implementations consistent with the present disclosure may include more or fewer zones within a space without departing from the spirit and scope of the present disclosure. Furthermore, although illustrated with zones fully covering the space 810, it should be appreciated that at least a portion of the space 810 might not be monitored by a sensor device 100. Although described with reference to spaces and/or monitored spaces, it should be appreciated that spaces as used herein in relation to a sensor device 100 may be synonymous with a zone of a space, for example, one of zones 810A, 810B, 810C, 810D, 810E, and/or 810F may correspond which one or more sensor device(s) as described herein without departing from the spirit and scope of the present disclosure.

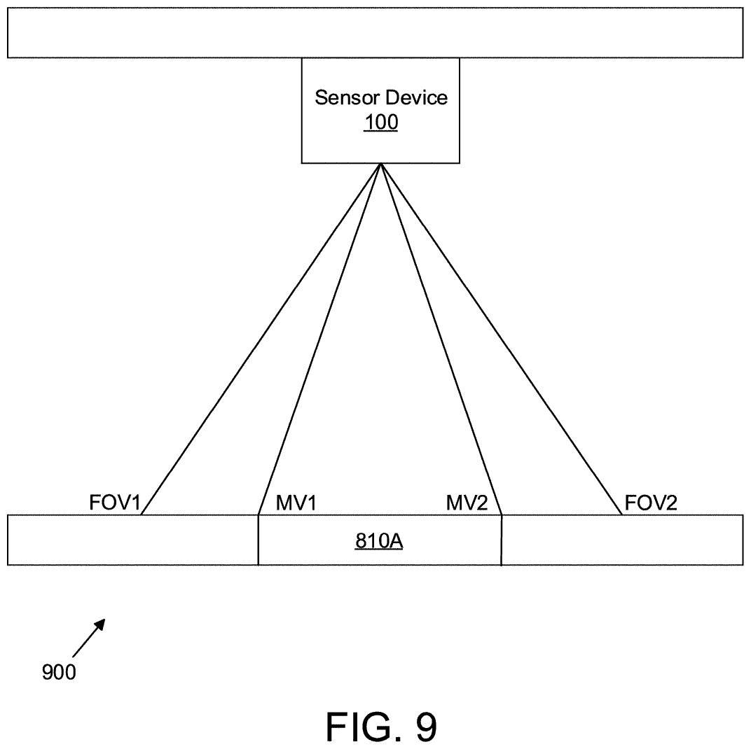

FIG. 9 illustrates an example of a limited monitoring zone of a sensor device in for a space having multiple zones as illustrated by FIG. 8B according to aspects of the present disclosure. The system 900 includes a sensor device 100 (e.g., sensor device 100A, which is a mounted device (e.g., mounted to a ceiling as illustrated by FIG. 9 but may be mountable to any surface) and which has a sensor Field of View (FOV) at an angle covering the distance within the space spanning from FOV1 to FOV2. The sensor device 100 (e.g., sensor device 100A) may be configured at time of installation or dynamically provisioned or configured to cover only a zone 810A of FIG. 8B by adjusting one or more of monitored view MV1 and/or MV2, for example by controlling a FOV angle from the sensor device 100 to the zone 810A. This may provide the ability to monitor a space not capable of monitoring via a single sensor device 100. One or more sensor device 100 configured to monitor at least a portion of a zone may be configured to update baseline or background data independently and/or in a coordinated fashion with one or more other sensor devices 100 (for example, as coordinated by a room and/or building controller or other element).

Implementations consistent with the present disclosure may include a sensor device for monitoring a space. The sensor may include a first sensor configured to capture baseline data and current data associated with the space, a second sensor configured to detect motion within the space, and a processor configured to cause the first sensor to capture the baseline data based at least in part upon a predetermined time period having elapsed since detected motion by the second sensor, the processor further configured to cause the second sensor to capture the current data and to perform a comparison operation on the current data and the baseline data. The first sensor may be a thermal imager. The second sensor may be a Passive Infrared (PIR) sensor. In various embodiments, the first sensor may be a thermal imager and the second sensor may be a PIR sensor. The comparison operation may perform people counting to determine a number of people within the space. The comparison operation may include comparing a reference background image as the baseline data to the current data. The reference background image may be a baseline background thermal image captured by the first sensor.

Further implementations according to aspects of the present disclosure may provide a system for monitoring a space. The system may include a management system, a network, and a sensor device. The sensor device may include a first sensor configured to capture baseline data and current data associated with the space, a second sensor configured to detect motion within the space, and a processor configured to cause the first sensor to capture the baseline data based at least in part upon a predetermined time period having elapsed since detected motion by the second sensor, the processor further configured to cause the second sensor to capture the current data and to perform a comparison operation on the current data and the baseline data. The first sensor may be a thermal imager. The second sensor may be a Passive Infrared (PIR) sensor. In various embodiments, the first sensor may be a thermal imager and the second sensor may be a PIR sensor. The comparison operation may perform one or more people counting operations to determine a number of people within the space. The comparison operation may include comparing a reference background image as the baseline data to the current data. The reference background image may be a baseline background thermal image captured by the first sensor.

According to further aspects of the present disclosure, provided is a method for providing improved people counting. The method includes obtaining baseline data relating to a space, selectively replacing the baseline data with new baseline data based at least in part upon a parameter of the space, obtaining current data relating to a space, comparing the current data to the baseline data, and determining a number of people within the space based at least in part upon the comparison between the current data to the baseline data. The method may further include performing one or more of a correction or a stabilization operation on the current data. The e comparing the current data to the baseline data may include comparing a baseline background thermal image to the current data.

Further implementations according to aspects of the present disclosure may include a non-transitory computer-readable storage medium having stored thereon sequences of instructions which when executed by a processor cause the processor to obtain baseline data relating to a space, selectively replace the baseline data with new baseline data based at least in part upon a parameter of the space, obtain current data relating to the space, compare the current data to the baseline data, and determine a number of people within the space based at least in part upon the comparison between the current data to the baseline data. The processor may further perform one or more of a correction or a stabilization operation on the current data. The e comparing the current data to the baseline data may include comparing a baseline background thermal image to the current data.

A sensor device 100 may include one or more zone-based (e.g., segment-based) people count inputs. A clock of the sensor device 100 may be configured to be synchronized by a controller such as an RP-C controller, which may be configured, for example, by a building management system server in various embodiments. The first sensor 130 of a sensor device 100 may be configured to obtain an image every two minutes and that image may be compared to a baseline (e.g., background) image to allow people counting operations described herein. A sensor device 100 may be associated with a particular zone (e.g., segment) and a people count value may be associated with both the sensor device 100 and/or zone. A people count operation consistent with the present disclosure may be configured to be performed at a predetermined time, for example every two minutes (although any other time may be specified or determined in accordance with the present disclosure). An image obtained by the first sensor 130 may be associated with a camera mode. The camera mode may include a normal mode or a degraded mode. The normal mode may indicate that the image was obtained at a proper time and that the background image has been properly refreshed. The degraded mode may indicate that the baseline image is not reliable for one or more reasons, such as no longer being current or that the image was not taken at the proper time.

In various exemplary embodiments, a user may trigger or force a new background image, for example using an interface associated with the sensor device 100 and/or building management system. This may be true regardless of whether the sensor device 100 operates in a manual or automatic configuration. If the refresh background mode is set to Automatic, the background (e.g., baseline data) may be automatically refreshed at the time specified in the refresh background time configuration (or by using the Refresh background image command). If the refresh background mode is set to Manual, the background (e.g., baseline data) may only be refreshed when a refresh background image command is executed. In degraded mode, the sensor device 100 may be configured to still count people. However, there is no guaranteed that the count will be correct. As a result, implementations consistent with the present disclosure while operating in the manual configuration may include determining that no one is present when the background image picture is taken. For example, a user may request a manual background update to refresh the picture at a time when a monitored space is believed to be empty, or the sensor device 100 may be configured in an automatic mode to update background data at midnight under the assumption that the monitored space will be unoccupied.

Implementations consistent with the present disclosure may include a minimum no motion time property. The Minimum no motion time property may permit specification of a time that no motion is detected by the second sensor 150 (e.g., the PIR sensor) before a refresh background is triggered. If the PIR sensor does not detect motion in the last Minimum no motion time seconds, the background image refresh may occur directly on executing the command. The default for the Minimum no motion time property may be set to ten minutes, although additional or alternative times may be used without departing from the spirit and scope of the present disclosure.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments, and advantages are merely illustrative and are not considered elements or limitations of the appended claims except where explicitly recited in a claim(s).

The various embodiments disclosed herein may be implemented as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A sensor device for monitoring a space, comprising:
a first sensor configured to capture baseline data and current data associated with the space;
a second sensor configured to detect motion within the space; and
a processor configured to cause the first sensor to capture the baseline data based at least in part upon a predetermined time period having elapsed since detected motion by the second sensor, the processor further configured to cause the second sensor to capture the current data and to perform a comparison operation on the current data and the baseline data.

2. The sensor device of claim 1, wherein the first sensor is a thermal imager.

3. The sensor device of claim 1, wherein the second sensor is a Passive Infrared (PIR) sensor.

4. The sensor device of claim 1, wherein the first sensor is a thermal imager and the second sensor is a PIR sensor.

5. The sensor device of claim 1, wherein the comparison operation is configured to perform people counting to determine a number of people within the space.

6. The sensor device of claim 1, wherein the comparison operation includes comparing a reference background image as the baseline data to the current data.

7. The sensor device of claim 6, wherein the reference background image is a baseline background thermal image captured by the first sensor, and wherein the second sensor is a Passive Infrared (PIR) sensor.

8. A system for monitoring a space, comprising:
a management system;
a network; and
a sensor device, comprising:
a first sensor configured to capture baseline data and current data associated with the space;
a second sensor configured to detect motion within the space; and
a processor configured to cause the first sensor to capture the baseline data based at least in part upon a predetermined time period having elapsed since detected motion by the second sensor, the processor further configured to cause the second sensor to capture the current data and to perform a comparison operation on the current data and the baseline data.

9. The system of claim 8, wherein the first sensor is a thermal imager.

10. The system of claim 8, wherein the second sensor is a Passive Infrared (PIR) sensor.

11. The system of claim 8, wherein the first sensor is a thermal imager and the second sensor is a PIR sensor.

12. The system of claim 8, wherein the comparison operation is configured to perform people counting to determine a number of people within the space.

13. The system of claim 8, wherein the comparison operation includes comparing a reference background image as the baseline data to the current data.

14. The system of claim 13, wherein the reference background image is a baseline background thermal image captured by the first sensor, and wherein the second sensor is a Passive Infrared (PIR) sensor.

15. A method for providing improved people counting, comprising:
obtaining baseline data relating to a space;
selectively replacing the baseline data with new baseline data based at least in part upon a parameter of the space;
obtaining current data relating to the space;
comparing the current data to the baseline data; and
determining a number of people within the space based at least in part upon the comparison between the current data to the baseline data.

16. The method of claim 15, further comprising:
performing one or more of a correction or a stabilization operation on the current data.

17. The method of claim 15, wherein the comparing the current data to the baseline data includes comparing a baseline background thermal image to the current data.

18. A non-transitory computer-readable storage medium having stored thereon sequences of instructions which when executed by a processor cause the processor to:
obtain baseline data relating to a space;
selectively replace the baseline data with new baseline data based at least in part upon a parameter of the space;
obtain current data relating to the space;
compare the current data to the baseline data; and
determine a number of people within the space based at least in part upon the comparison between the current data to the baseline data.

19. The non-transitory computer-readable storage medium of claim 18, further comprising causing the processor to:
perform one or more of a correction or a stabilization operation on the current data.

20. The non-transitory computer-readable storage medium of claim 18 wherein the comparing the current data to the baseline data includes comparing a baseline background thermal image to the current data.
